(19) United States
(12) Patent Application Publication
(10) Pub. No.: US 2010/0056079 A1
(43) Pub. Date: Mar. 4, 2010

(54) RETRANSMISSION BETWEEN DCI FORMAT 1A AND FORMAT 2/2A

(75) Inventors: Eko N. Onggosanusi, Allen, TX (US); Runhua Chen, Dallas, TX (US); Anand G. Dabak, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/554,562

(22) Filed: Sep. 4, 2009

Related U.S. Application Data
(60) Provisional application No. 61/094,293, filed on Sep. 4, 2008.
(60) Provisional application No. 61/099,109, filed on Sep. 22, 2008.

(51) Int. Cl. H04B 1/034; G06F 3/033

(52) U.S. Cl. 455/95; 455/130

(57) ABSTRACT

A transmitter is for use with a cellular communication network and includes a downlink control information (DCI) configuration unit that designates a DCI format for a downlink transmission selected from a first DCI format intended for a single transport block contiguous resource block transmission and a second DCI format intended for a dual transport block transmission available for spatial multiplexing. The transmitter also includes a retransmission coordination unit configured to facilitate a retransmission for the downlink transmission of a transport block corresponding to the first DCI format using the second DCI format or one of the dual transport blocks corresponding to the second DCI format using the first DCI format, based on a retransmission rule.

### CROSS-REFERENCE TO PROVISIONAL APPLICATION

This application claims the benefit of U.S. Provisional Application No. 61/094,293, filed by Eko N. Onggosanusi, Runhua Chen and Anand G. Dabak on Sep. 4, 2008, entitled “Retransmission Between DCI Format 1A and 2” commonly assigned with this application and incorporated herein by reference.

This application also claims the benefit of U.S. Provisional Application No. 61/099,109, filed by Eko N. Onggosanusi, Runhua Chen and Anand G. Dabak on Sep. 22, 2008, entitled “Retransmission Between DCI Format 1A and 2” commonly assigned with this application and incorporated herein by reference.

### TECHNICAL FIELD

The present disclosure is directed, in general, to a communication system and, more specifically, to a transmitter, a receiver and methods of operating a transmitter and a receiver.

### BACKGROUND

In a cellular network such as one employing orthogonal frequency division multiple access (OFDMA), each communication cell employs a base station that communicates with user equipment. MIMO communication systems offer increases in throughput due to their ability to support multiple parallel data streams that are each transmitted from different antennas. These systems provide increased data rates and reliability by exploiting spatial multiplexing gain or spatial diversity gain that is available to MIMO channels. Of particular interest is the 3GPP Long-Term Evolution (LTE) cellular standard, also known as the E-UTRA. Although current reliability is acceptable, improvements in this area would prove beneficial in the art.

### SUMMARY

Embodiments of the present disclosure provide a transmitter, a receiver and methods of operating a transmitter and a receiver. In one embodiment, the transmitter is for use with a cellular communication network and includes a downlink control information (DCI) configuration unit that designates a DCI format for a downlink transmission selected from a first DCI format intended for a single transport block contiguous resource block transmission and a second DCI format intended for a dual transport block transmission available for spatial multiplexing. The transmitter also includes a retransmission coordination unit configured to facilitate a retransmission for the downlink transmission of a transport block corresponding to the first DCI format using the second DCI format or one of the dual transport blocks corresponding to the second DCI format using the first DCI format, based on a retransmission rule.

In another embodiment, the receiver is for use with a cellular communication network and includes a receive unit that receives a downlink control information (DCI) format for a downlink transmission selected from a first DCI format intended for a single transport block contiguous resource block transmission and a second DCI format intended for a dual transport block transmission available for spatial multiplexing. The receiver also includes a retransmission decoding unit configured to decode a retransmission for the downlink transmission of a transport block corresponding to the first DCI format using the second DCI format or one of the dual transport blocks corresponding to the second DCI format using the first DCI format, based on a retransmission rule.

In another aspect, the method of operating a transmitter is for use with a cellular communication network and includes designating a downlink control information (DCI) format for a downlink transmission selected from a first DCI format intended for a single transport block contiguous resource block transmission and a second DCI format intended for a dual transport block transmission available for spatial multiplexing. The method of operating a transmitter also includes facilitating a retransmission for the downlink transmission of a transport block corresponding to the first DCI format using the second DCI format or one of the dual transport blocks corresponding to the second DCI format using the first DCI format, based on a retransmission rule.

In yet another aspect, the method of operating a receiver is for use with a cellular communication network and includes receiving a downlink control information (DCI) format for a downlink transmission selected from a first DCI format intended for a single transport block contiguous resource block transmission and a second DCI format intended for a dual transport block transmission available for spatial multiplexing. The method of operating a receiver also includes decoding a retransmission for the downlink transmission of a transport block corresponding to the first DCI format using the second DCI format or one of the dual transport blocks corresponding to the second DCI format using the first DCI format, based on a retransmission rule.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates an exemplary diagram of a cellular communication network employing embodiments of a transmitter and a receiver constructed according to the principles of the present disclosure;

FIGS. 2A and 2B illustrate two possible retransmission scenarios between DCI formats 1A and 2/2A as may be employed in the cellular communication network of FIG. 1;

FIG. 3 illustrates a flow diagram of an embodiment of a method of operating a transmitter carried out according to the principles of the present disclosure; and

FIG. 4 illustrates a flow diagram of an embodiment of a method of operating a receiver carried out according to the principles of the present disclosure.

### DETAILED DESCRIPTION

When user equipment (UE) is semi-statically configured for open-loop or closed-loop spatial multiplexing (OL/CL SM) in the LTE system, a downlink (DL) grant from a base station (eNB) for the UE is associated with a Downlink Control Information (DCI) format 2 or 2A, which allows multiple layer transmission. DCI format 2 is designated for CL SM while DCI format 2A is associated with OL SM, which is a more compact version of format 2. In addition, the UE is allowed to receive a DL grant with a DCI format 1A (i.e., DCI format 1A, which only allows a single-layer transmission with contiguous resource block allocation). This is also known as the compact DCI format. That is, a UE configured for OL/CL SM may receive a DL grant with DCI format 1A or DCI format 2/2A in a given subframe.

Note that for the LTE system, single-layer transmission is associated with a single transport block (TB). Multi-layer transmission, on the other hand, is associated with two distinct TBs where the two different TBs are mapped onto the different layers.

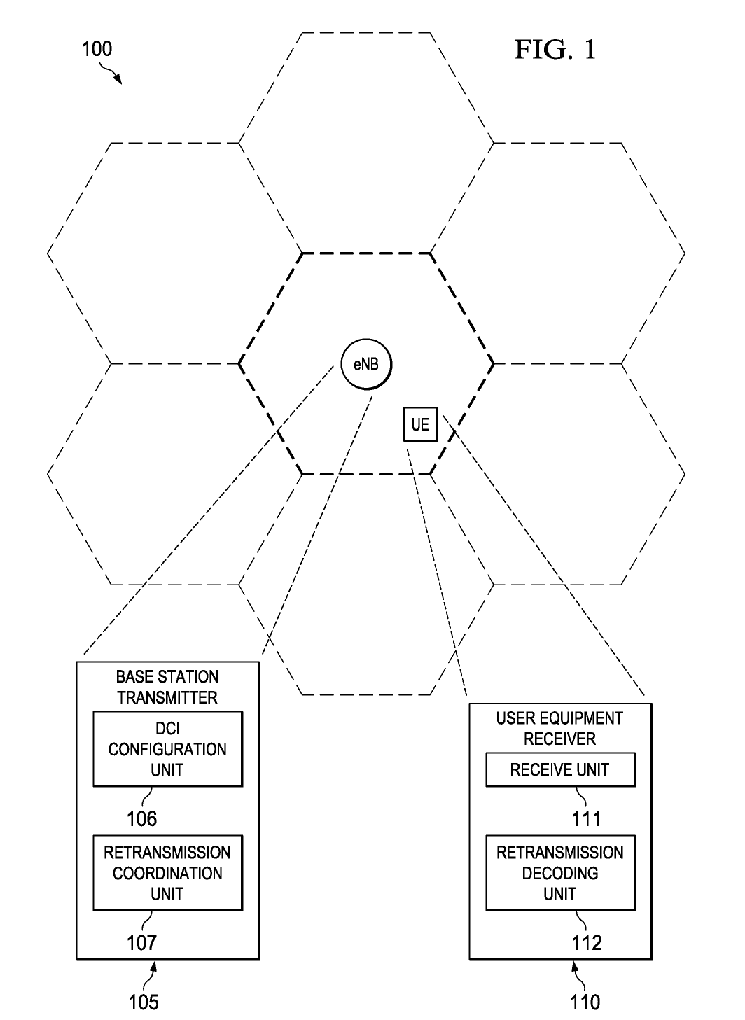

FIG. 1 illustrates an exemplary diagram of a cellular communication network 100 employing embodiments of a transmitter and a receiver constructed according to the principles of the present disclosure. In the illustrated embodiment, the cellular communication network 100 is part of an OFDM system and includes a cellular grid having a centric cell and six surrounding first-tier cells. The centric cell employs a centric base station eNB that includes a base station transmitter 105. The base station transmitter 105 includes a downlink control information (DCI) configuration unit 106 and a retransmission coordination unit 107. User equipment (UE) is located in the centric cell, as shown. The UE includes a receiver 110 having a receive unit 111 and a retransmission decoding unit 112.

In the base station transmitter 105, the DCI configuration unit 106 designates a DCI format for a downlink transmission selected from a first DCI format intended for a single transport block contiguous resource block transmission and a second DCI format intended for a dual transport block transmission available for spatial multiplexing.

Correspondingly, the retransmission coordination unit 107 is configured to facilitate a retransmission for the downlink transmission of a transport block corresponding to the first DCI format using the second DCI format or one of the dual transport blocks corresponding to the second DCI format using the first DCI format, based on a retransmission rule.

In the UE receiver 110, the receive unit 111 receives a downlink control information (DCI) format for a downlink transmission selected from a first DCI format intended for a single transport block contiguous resource block transmission and a second DCI format intended for a dual transport block transmission available for spatial multiplexing. The retransmission decoding unit 112 is configured to decode a retransmission for the downlink transmission of a transport block corresponding to the first DCI format using the second DCI format or one of the dual transport blocks corresponding to the second DCI format using the first DCI format, based on a retransmission rule.

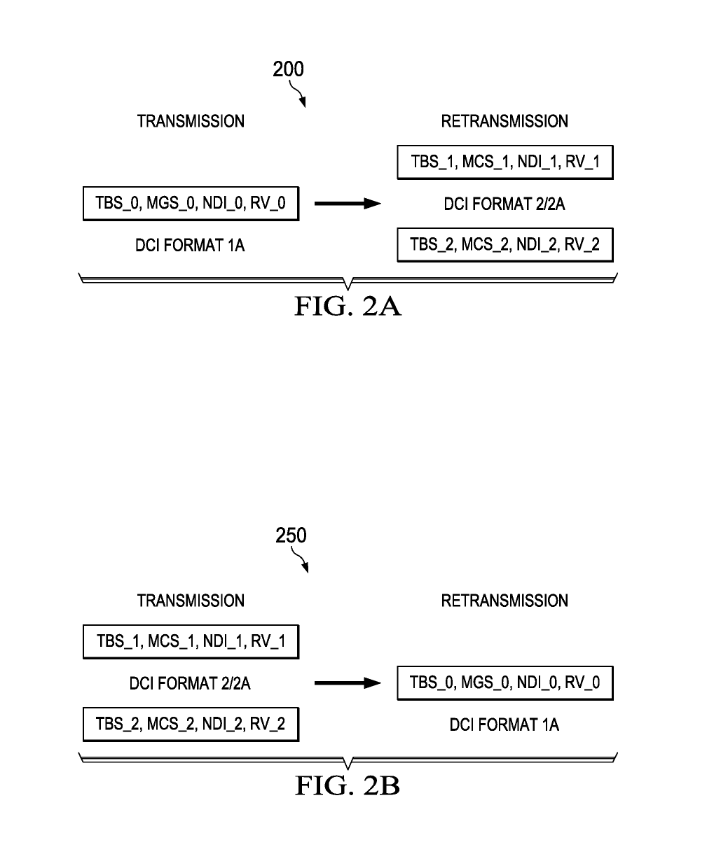

FIGS. 2A and 2B illustrate two possible retransmission scenarios 200, 250 between DCI formats 1A and 2/2A as may be employed in the cellular communication network 100 of FIG. 1. The retransmission scenario 200 represents a transmission in a DCI format 1A that changes to a DCI format 2/2A for its retransmission. Correspondingly, the retransmission scenario 250 represents a transmission in a DCI format 2/2A that changes to a DCI format 1A for its retransmission. Each of the transport blocks is associated with a TB size (TBS), modulation-and-coding scheme (MCS) flag, new data indicator (NDI), and redundancy version (RV).

In shifting from a DCI format 1A to a DCI format 2/2A as shown in FIG. 2A, a transport block (TB) in a transmission associated with DCI format 1A is retransmitted using DCI format 2/2A together with another TB thereby forming a two transport block transmission. This may occur when both of the followings conditions are true. The channel rank increases from n=1 to n>1, which allows a multiple layer transmission and a larger DL grant having more flexibility (i.e., DCI format 2/2A). A DL data buffer for the UE allows the eNB to transmit an additional TB.

In shifting from a DCI format 2/2A to a DCI format 1A as shown in FIG. 2B, one of the two TBs in a transmission associated with DCI format 2/2A is retransmitted using DCI format 1A. This may occur due to at least one of the following reasons. The channel rank drops from n>1 to n=1, which necessitates a single-layer transmission as well as a low-budget or compact DL grant (i.e., DCI format 1A). One of the two TBs is successfully decoded by the UE and a DL data buffer for the UE is empty.

In the above scenarios, the UE is required to determine which of the two TBs is the retransmitted TB associated with DCI format 1A. Failure to determine this typically leads to misidentification of the data buffer location. Embodiments of the present disclosure provide solutions to alleviate this problem.

In relation to determining which of the two TBs corresponds to the single TB identified in DCI format 1A, the following HARQ (Hybrid Automatic Repeat Request) operation rules are relevant for the UE. TBS may be used to help identify the TB of interest except when the two TBs share the same TBS. NDI is incremented (toggled) upon transmission of a new TB. Otherwise, NDI stays the same. The NDI toggling may be used (as opposed to setting NDI=1 for a new transmission and NDI=0 for retransmission) to avoid soft combining across several different transmissions when the DL grant associated with the new transmission is missed.

A new DL transmission does not necessarily correspond to RV=0. Hence, RV may not be used to differentiate a new transmission from a retransmission. MCS=29, 30, 31 is used only for retransmission to indicate that the TBS associated with the current DL grant is the same as that associated with the previous DL grant. However, MCS 0-28 can also be used for retransmission as well as a new transmission.

When used for a retransmission, MCS=29, 30, 31 is suitable when the eNB is equipped with reliable DTX detection capability. Upon detecting a DTX (missed DL grant), the eNB resends the previous TB as if it were a new transmission (with the same NDI value as the missed transmission). MCS 0-28 are suitable when the eNB is not equipped with reliable DTX detection capability (e.g., format 2a/2b PUCCH, multi-ACK/NAK transmission for TDD, low-budget eNB). In this case, the use of MCS=29, 30, 31 prevents the UE from detecting the TBS for the retransmission if the initial transmission of the TBS is missed. Some solutions are presented below for a retransmission of DCI format 1A with DCI format 2/2A and DCI format 2/2A with 1A.

First, possible solutions to resolve the retransmission issues between DCI format 1A and 2/2A are presented. For a retransmission of DCI format 1A with DCI format 2/2A, different scenarios and solutions are given in Table 1. It is assumed that the UE fails to decode the transmission associated with the DCI format 1A and reports a NAK to the eNB.

TABLE 1
Scenarios and Solutions for Retransmission of DCI
Format 1A with DCI Format 2/2A

| | | | Solution to | |
|---|---|---|---|---|
| | | | determine which | |
| | | | TB corresponds | |
| | | | to a | |
| | | | retransmission | |
| Case | TBS/MCS | NDI | of 1A | Comments |
| 1 | TBS_1 ≠ TBS_2 | Does not | Determine | |
| | | matter | which TBS_1 | |
| | | | and TBS_2 is | |
| | | | equal to | |
| | | | TBS_0 | |
| 2 | TBS_1 = TBS_2 | NDI_1 ≠ NDI_2 | Determine | This is still a |
| | | | which of | problem when ACK |
| | | | NDI_1 and | is detected as |
| | | | NDI_2 is | NAK at the eNB |
| | | | equal to | since the initial |
| | | | NDI_0 | state of NDI may |
| | | | | overlap with at |
| | | | | least one of the |
| | | | | NSI values. |
| 3 | TBS_1 = TBS_2 | NDI_1 = NDI_2 ≠ | No solution | The TB |
| | | NDI_0 | needed | corresponding to |
| | | | | DCI format 1A is |
| | | | | lost. Both TBs |
| | | | | in DCI format |
| | | | | 2/2A are assumed |
| | | | | new |
| | | | | transmissions. |
| 4 | TBS_1 = TBS_2, | NDI_1 = NDI_2 = | Determine | Occur when the |
| | one of the | NDI_0 | which of the | value of NDI_0 |
| | MSC_1 and | | MCS_1 and | is the initial |
| | MCS_2 takes | | MCS_2 takes | state of NDI |
| | value from | | value from | (before the |
| | 29, 30, 31 | | 29, 30, 31. | very first |
| | | | | transmission). |
| | | | | Cannot be |
| | | | | solved via NDI |
| 5 | TBS_1 = TBS_2, | NDI_1 = NDI_2 = | Currently no | Occur when the |
| | both MCS_1 | NDI_0 | solution | value of NDI_0 |
| | and MCS_2 | | | is the initial |
| | take value | | | state of NDI |
| | from 0, 1, . . . , 28 | | | (before the |
| 6 | TBS_1 = TBS_2, | | | very first |
| | both MCS_1 | | | transmission). |
| | and MCS_2 | | | Cannot be |
| | takes value | | | solved via NDI |
| | from 29, 30, 31 | | | and TBS |

As identified above, the most problematic scenario occurs when TBS_{—}1=TBS_{—}2 and NDI_{—}1=NDI_{—}2=NDI_{—}0. Several solutions are possible. In a first alternative, MSC=29, 30, 31 are used only for retransmission to indicate the modulation order (already specified). Conversely, MCS=0, 1, . . . , 28 are used only for a new transmission (needs to be specified). This enables the UE to differentiate retransmission and new transmission apart from the NDI. A drawback includes precluding MCS 0-28 for retransmission is problematic when eNB lacks the capability of DTX detection.

In a second alternative, only one of the two TBs (either the first or the second TB) in DCI format 2/2A may be used for the retransmission of DCI format 1A. Note that NDI_{—}1=NDI_{—}2=NDI_{—}0 cannot happen when both TBs are new transmissions, since one of the NDIs is toggled. The transport block-to-codeword swap flag may be used to assign the codeword for the designated TB is associated with retransmission. For example, retransmission of the TB associated with DCI format 1A with the first TB of DCI format 2/2A using the first or second codeword may be indicated with HARQ swap flag=0/1.

In a third alternative, CRC masking may be applied to indicate which of the two TBs represents retransmission of the TB from DCI format 1A. For example, a first mask (mask1) may indicate that there is no retransmission from DCI format 1A. A second mask (mask2) may indicate a first TB is the retransmission from format 1A, and a third mask (mask3) may indicate a second TB is the retransmission from DCI format 1A. This advantageously provides a unique identification. However, significant changes to the PHY-layer specification and reduction in the total number of Cell Radio Network Temporary Identifiers (C-RNTIs) used for UE identifications (IDs) may be necessary.

In a fourth alternative, the possibility of switching a retransmission of the same TB from DCI format 1A to DCI format 2/2A may be precluded to avoid the switching problem altogether. Any combination of the above alternatives is also possible.

Among the DCI format retransmission alternatives just discussed, the first alternative may provide a more limiting solution since it may be unreasonable to ensure that all eNBs are equipped with reliable DTX detection capability. Hence, the first alternative may be the least preferred. The fourth alternative is, perhaps, the simplest yet restrictive in another manner (i.e., it precludes switching from DCI format 1A to DCI format 2/2A altogether). The third alternative is a robust solution if reducing the available number of C-RNTIs is not a concern. Otherwise, the third alternative is quite attractive while providing comparable benefits to the second alternative.

Now consider solutions to resolve retransmission issues when replacing DCI format 2/2A with DCI format 1A. Different scenarios and possible solutions are shown in Table 2. It is assumed that the UE fails to decode at least one of the two TBs associated with the DCI format 2/2A and reports the corresponding NAK(s) to the eNB.

TABLE 2
Scenarios and Solutions for Retransmission of DCI
Format 2/2A with DCI Format 1A

| | | | Solution to | |
|---|---|---|---|---|
| | | | Determine which TB | |
| | | | Corresponds to | |
| | | | Retransmission with | |
| Case | TBS/MCS | NDI | Format 1A | Comments |
| 1 | TBS_1 ≠ TBS_2 | Does | Determine which of | |
| | | not | TBS_1 and TBS_2 is | |
| | | matter | equal to TBS_0 | |
| 2 | TBS_1 = TBS_2 | NDI_1 ≠ | Determine which of | This is still a |
| | | NDI_2 | NDI_1 and NDI_2 is | problem when |
| | | | equal to NDI_0 | ACK is detected |
| | | | | as NAK at the |
| | | | | eNB → can be |
| | | | | solved with Alt |
| | | | | 1 or Alt 4 below. |
| | | | | In addition, |
| | | | | ambiguity |
| | | | | occurs between |
| | | | | a new transmission |
| | | | | with DCI format |
| | | | | 1A and a |
| | | | | retransmission |
| | | | | of one of the TBs |
| 3 | TBS_1 = TBS_2 | NDI_1 = | No solution needed | Lost TB(s). The |
| | | NDI_2 ≠ | | TB corresponding |
| | | NDI_0 | | to DCI format 1A |
| | | | | is a new |
| | | | | transmission. |
| 4 | TBS_1 = TBS_2, | NDI_1 = | Determine which of | Occur when the |
| | one of the | NDI_2 = | the MCS_1 and MCS_2 | value of NDI_0 |
| | MCS_1 and | NDI_0 | takes value from | is the initial |
| | MCS_2 takes | | 29, 30, 31 | state of NDI |
| | value from | | | (before the very |
| | 29, 30, 31 | | | first transmission). |
| | | | | Cannot be |
| | | | | solved via NDI |
| 5 | TBS_1 = TBS_2, | NDI_1 = | If only 1 of the | Occur when the |
| | both MCS_1 | NDI_2 = | 2 TBs was NAKed: | value of NDI_0 |
| | and MCS_2 | NDI_0 | determine which | is the initial |
| | take value | | of the 2 TBs was | state of NDI |
| | from 0, 1, . . . , 28 | | NAKed + the | (before the |
| 6 | TBS_1 = TBS_2, | | value of swap | very first |
| | both MCS_1 | | bit. | transmission). |
| | and MCS_2 | | If both TBs were | Cannot be |
| | takes value | | NAKed: | solved via NDI |
| | from 29, 30, | | currently no | and TBS |
| | 31 | | solution. | The solution |
| | | | | relying on UL |
| | | | | ACK/NAK may |
| | | | | result in error |
| | | | | cases due to |
| | | | | the non-ideal |
| | | | | UL ACK/NAK |
| | | | | detection |

As identified in Table 2, a most problematic scenario occurs when TBS_{—}1=TBS_{—}2 and NDI_{—}1=NDI_{—}2=NDI_{—}0. Several solutions are possible. In a first alternative, MCS=29, 30, 31 are used only for retransmission to indicate the modulation order. Conversely, MsC=0, 1, . . . , 28 are used only for new transmission. This enables the UE to differentiate retransmission and new transmission apart from NDI. However, precluding MCS 0-28 for retransmission is problematic when the eNB lacks DTX detection capability.

In a second alternative, specify that only the TB associated with one of two codewords (either the first or the second codeword) in DCI format 2/2A can be retransmitted using DCI format 1A. For example, if the designated codeword is the first codeword, only the TB associated with the first codeword can be retransmitted with DCI format 1A if the starting or previous DCI format is DCI format 2/2A. The mapping is indicated with the one bit TB-to-codeword swap flag, (e.g., a value of zero or one indicates that the first or second TB is associated with the first codeword).

Also, If the TB associated with the first codeword can be decoded successfully (and the eNB receives the ACK correctly), but the TB associated with the second codeword needs retransmission (e.g., in a retransmission n−1), DCI format 1A cannot be used for retransmitting the TB associated with the second codeword in the subsequent retransmission n. In this case, DCI format 2/2A needs to be used for this purpose. It is possible, however, to use DCI format 1A for retransmitting the TB associated with the second codeword in a retransmission n+1. For this, the TB is first retransmitted with the first codeword in retransmission n. This is configured automatically when only one TB is left in DCI format 2/2A. Otherwise, this can be accomplished by changing the value of a TB-to-codeword swap flag. Then, if the retransmission n+1 is needed, switching from DCI format 2/2A to 1A is permitted.

Additionally, if both TBs need to be retransmitted, the TB associated with the second codeword can be retransmitted using DCI format 1A only if the TB associated with the first codeword is cleared (i.e., does not need to be retransmitted). In this case, accommodating the (temporary) termination of the TB associated with the second codeword may be resolved as a scheduler implementation.

Yet, it is also possible to specify a fixed mapping rule in terms of TB. That is, specify that only one of the two TBs (either the first or the second TB) in DCI format 2/2A can be retransmitted using DCI format 1A. This, however, has a drawback of not being able to retransmit the second TB regardless of the TB-to-codeword swap flag. It is, however, still a feasible alternative (e.g., specify that only the first TB of DCI format 2/2A can be retransmitted with DCI format 1A).

In a third alternative, CRC masking may be applied on DCI format 1A to indicate which of the two TBs from DCI format 2/2A is retransmitted in DCI format 1A (e.g., mask1 represents no retransmission, mask 2 represents retransmission of the first TB from DCI format 2/2A and mask3 represents retransmission of the second TB from DCI format 2/2A).

In a fourth alternative, preclude the possibility of switching the DCI format from 2/2A to 1A upon retransmitting the same TB, which avoids the switching problem altogether. Any combination of the above alternatives is also possible.

Among the DCI format retransmission alternatives discussed directly above, the first alternative may be a most limiting solution since it may be unreasonable to ensure that all eNBs are equipped with the reliable DTX detection capability. Hence, the first alternative is the perhaps the least preferred. The fourth alternative is the simplest yet restrictive in another manner (i.e., precluding switching for retransmission from DCI format 2/2A to 1A altogether). The third alternative is a robust solution if reducing the available number of C-RNTIs is not a concern. Otherwise, the second alternative is also attractive despite a slight restriction concerning the inability to retransmit the second TB right away.

Embodiments of the present disclosure provide several solutions, which include using MCS 29-31, CRC masking and applying a predetermined retransmission rule, for example. These solutions have strengths and weaknesses such as the reliance of DTX detection capability, reducing the number of C-RNTIs and susceptibility to ACK/NAK detection error.

Based on the above discussions, if reducing the number of C-RNTIs and restricting the use of DCI format 1A are of concern, specifying a fixed mapping for switching between DCI format 1A and DCI format 2/2A upon retransmission is attractive. For example, in switching from DCI format 1A to DCI format 2/2A, the TB in DCI format 1A is retransmitted as the first TB in DCI format 2/2A. The associated codeword is indicated with the TB-to-codeword swap flag. In switching from DCI format 2/2A to DCI format 1A, only the TB associated with the first codeword in DCI format 2/2A is retransmitted with DCI format 1A, for example. A temporary termination of the other TB, if necessary, may be addressed as a scheduler implementation.

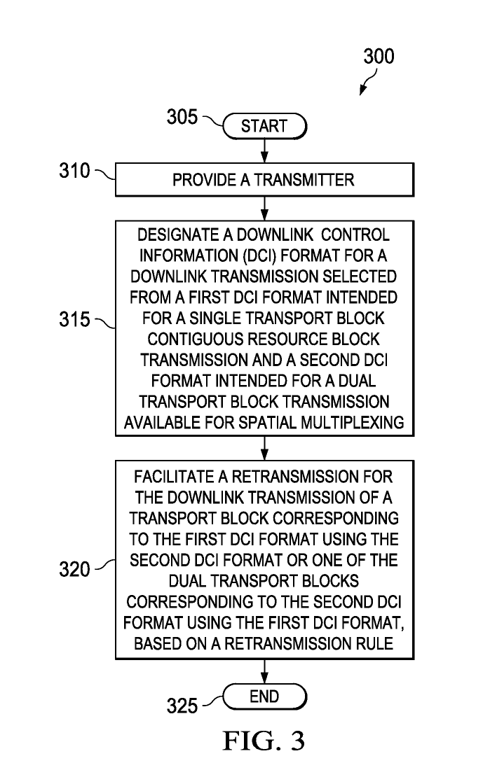

FIG. 3 illustrates a flow diagram of an embodiment of a method of operating a transmitter 300 carried out according to the principles of the present disclosure. The method 300 is for use with a cellular communication network and starts in a step 305. Then, in a step 310, a transmitter is provided and a downlink control information (DCI) format is designated for a downlink transmission selected from a first DCI format intended for a single transport block contiguous resource block transmission and a second DCI format intended for a dual transport block transmission available for spatial multiplexing, in a step 315.

A retransmission is facilitated for the downlink transmission of a transport block corresponding to the first DCI format using the second DCI format or one of the dual transport blocks corresponding to the second DCI format using the first DCI format, based on a retransmission rule, in a step 320.

In one embodiment, the retransmission rule specifies that only one of a first or second transport block in the second DCI format corresponds to the retransmission. In another embodiment, the retransmission rule corresponds to a modulation and coding scheme flag that is used only for the retransmission. In yet another embodiment, the retransmission rule includes providing an HARQ swap flag that specifies which of a first or second transport block in the second DCI format corresponds to the retransmission. In a further embodiment, the retransmission rule includes applying a CRC masking that specifies which of a first or second transport block in the second DCI format corresponds to the retransmission. The method 300 ends in a step 325.

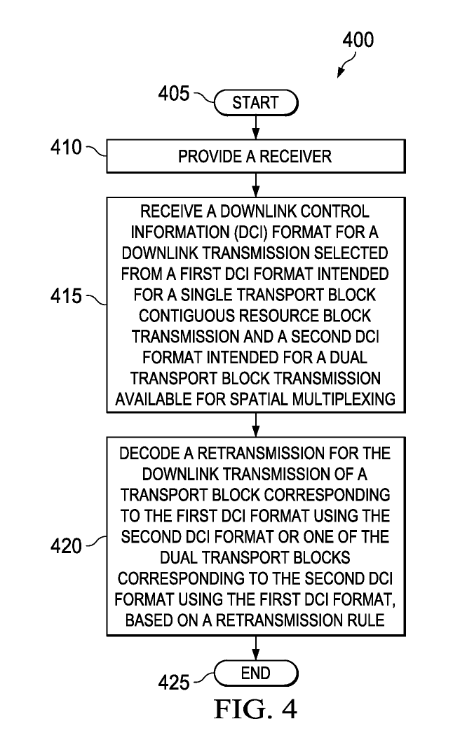

FIG. 4 illustrates a flow diagram of an embodiment of a method of operating a receiver 400 carried out according to the principles of the present disclosure. The method 400 is for use with a cellular communication network and starts in a step 405. Then, in a step 410, a receiver is provided, and a downlink control information (DCI) format is received for a downlink transmission selected from a first DCI format intended for a single transport block contiguous resource block transmission and a second DCI format intended for a dual transport block transmission available for spatial multiplexing, in a step 415.

A retransmission is decoded for the downlink transmission of a transport block corresponding to the first DCI format using the second DCI format or one of the dual transport blocks corresponding to the second DCI format using the first DCI format, based on a retransmission rule, in a step 420.

In one embodiment, the retransmission rule specifies that only one of a first or second transport block in the second DCI format corresponds to the retransmission. In another embodiment, the retransmission rule corresponds to a modulation and coding scheme flag that is used only for the retransmission. In yet another embodiment, the retransmission rule includes providing an HARQ swap flag that specifies which of a first or second transport block in the second DCI format corresponds to the retransmission. In a further embodiment, the retransmission rule includes applying a CRC masking that specifies which of a first or second transport block in the second DCI format corresponds to the retransmission. The method 400 ends in a step 425.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A transmitter for use with a cellular communication network, comprising:
a downlink control information (DCI) configuration unit that designates a DCI format for a downlink transmission selected from a first DCI format intended for a single transport block contiguous resource block transmission and a second DCI format intended for a dual transport block transmission available for spatial multiplexing; and
a retransmission coordination unit configured to facilitate a retransmission for the downlink transmission of a transport block corresponding to the first DCI format using the second DCI format or one of the dual transport blocks corresponding to the second DCI format using the first DCI format, based on a retransmission rule.

2. The transmitter as recited in claim 1 wherein the retransmission rule specifies that only one of a first or second transport block in the second DCI format corresponds to the retransmission.

3. The transmitter as recited in claim 1 wherein the retransmission rule corresponds to a modulation and coding scheme flag that is used only for the retransmission.

4. The transmitter as recited in claim 1 wherein the retransmission rule includes providing an HARQ swap flag that specifies which of a first or second transport block in the second DCI format corresponds to the retransmission.

5. The transmitter as recited in claim 1 wherein the retransmission rule includes applying a CRC masking that specifies which of a first or second transport block in the second DCI format corresponds to the retransmission.

6. A method of operating a transmitter for use with a cellular communication network, comprising:
designating a downlink control information (DCI) format for a downlink transmission selected from a first DCI format intended for a single transport block contiguous resource block transmission and a second DCI format intended for a dual transport block transmission available for spatial multiplexing; and
facilitating a retransmission for the downlink transmission of a transport block corresponding to the first DCI format using the second DCI format or one of the dual transport blocks corresponding to the second DCI format using the first DCI format, based on a retransmission rule.

7. The method as recited in claim 6 wherein the retransmission rule specifies that only one of a first or second transport block in the second DCI format corresponds to the retransmission.

8. The method as recited in claim 6 wherein the retransmission rule corresponds to a modulation and coding scheme flag that is used only for the retransmission.

9. The method as recited in claim 6 wherein the retransmission rule includes providing an HARQ swap flag that specifies which of a first or second transport block in the second DCI format corresponds to the retransmission.

10. The method as recited in claim 6 wherein the retransmission rule includes applying a CRC masking that specifies which of a first or second transport block in the second DCI format corresponds to the retransmission.

11. A receiver for use with a cellular communication network, comprising:
a receive unit that receives a downlink control information (DCI) format for a downlink transmission selected from a first DCI format intended for a single transport block contiguous resource block transmission and a second DCI format intended for a dual transport block transmission available for spatial multiplexing; and
a retransmission decoding unit configured to decode a retransmission for the downlink transmission of a transport block corresponding to the first DCI format using the second DCI format or one of the dual transport blocks corresponding to the second DCI format using the first DCI format, based on a retransmission rule.

12. The receiver as recited in claim 11 wherein the retransmission rule specifies that only one of a first or second transport block in the second DCI format corresponds to the retransmission.

13. The receiver as recited in claim 11 wherein the retransmission rule corresponds to a modulation and coding scheme flag that is used only for the retransmission.

14. The receiver as recited in claim 11 wherein the retransmission rule includes providing an HARQ swap flag that specifies which of a first or second transport block in the second DCI format corresponds to the retransmission.

15. The receiver as recited in claim 11 wherein the retransmission rule includes applying a CRC masking that specifies which of a first or second transport block in the second DCI format corresponds to the retransmission.

16. A method of operating a receiver for use with a cellular communication network, comprising:
receiving a downlink control information (DCI) format for a downlink transmission selected from a first DCI format intended for a single transport block contiguous resource block transmission and a second DCI format intended for a dual transport block transmission available for spatial multiplexing; and
decoding a retransmission for the downlink transmission of a transport block corresponding to the first DCI format using the second DCI format or one of the dual transport blocks corresponding to the second DCI format using the first DCI format, based on a retransmission rule.

17. The method as recited in claim 16 wherein the retransmission rule specifies that only one of a first or second transport block in the second DCI format corresponds to the retransmission.

18. The method as recited in claim 16 wherein the retransmission rule corresponds to a modulation and coding scheme flag that is used only for the retransmission.

19. The method as recited in claim 16 wherein the retransmission rule includes providing an HARQ swap flag that specifies which of a first or second transport block in the second DCI format corresponds to the retransmission.

20. The method as recited in claim 16 wherein the retransmission rule includes applying a CRC masking that specifies which of a first or second transport block in the second DCI format corresponds to the retransmission.
